(19) United States
(12) Patent Application Publication
(10) Pub. No.: US 2011/0095031 A1
(43) Pub. Date: Apr. 28, 2011

(54) Cooking Vessel Assembly and Lid for the Same

(75) Inventors: Michael Welk, Vernon Hills, IL (US); Tara Marie Marchionna, New York, NY (US); Paul Katz, New York, NY (US); Kirsten Jane Climer, New York, NY (US); Diana Beatriz Sierra, New York, NY (US); Bikramjeet Sohi, Buffalo Grove, IL (US); John Chap, Woodridge, IL (US); Davin Stowell, New York, NY (US)

(73) Assignee: WKI HOLDING COMPANY, INC., Rosemont, IL (US)

(21) Appl. No.: 12/792,486

(22) Filed: Jun. 2, 2010

Related U.S. Application Data
(63) Continuation of application No. 29/345,755, filed on Oct. 22, 2009, now Pat. No. D619892.

(51) Int. Cl. A47J 36/12

(52) U.S. Cl. 220/573.1; 220/831

(57) ABSTRACT

A cooking vessel assembly comprises a cooking vessel and a removable lid. The cooking vessel has a base and a continuous sidewall. The sidewall connects to the base, projecting upwardly from the base and terminates at a peripheral edge. The removable lid has a covering portion and a handle. The handle has a griping portion, a connecting section, and a supporting section. The connecting section connects the handle to the lid covering portion. The gripping section extends from the connecting section. The supporting section extends from the connecting section in a direction generally opposite of the gripping section and has a cooking vessel retaining portion. A gap is formed between the connecting section and the supporting section. The cooking vessel retaining portion receives the peripheral edge of the cooking vessel to secure the lid to the cooking vessel in an open position to allow access to the base of the cooking vessel.

### RELATED APPLICATIONS

The present application is a continuation of pending U.S. patent application Ser. No. 29/345,755 filed on Oct. 22, 2009, which is hereby incorporated by reference herein in its entirety.

### TECHNICAL FIELD

The present invention relates to a cooking vessel assembly, and more particularly, to a lid for a cooking vessel assembly adapted to engage a sidewall of the cooking vessel to allow a user to inspect the contents of the cooking vessel while funneling condensation into the vessel.

### BACKGROUND OF THE INVENTION

When cooking food it is common to use a cooking vessel, such as a pot or a pan, on a stovetop in order to cook or heat the food. Such a cooking vessel may be used for a variety of cooking methods such as boiling, frying, braising, simmering, steaming, and other known stovetop cooking methods. A lid is often utilized when the cooking vessel is utilized with a stovetop to form a cooking vessel assembly, such as to help retain heat within the cooking vessel, increase the pressure within the cooking vessel, or to prevent materials from entering or exiting the cooking vessel. However, a user often needs to be able to access the food within the cooking vessel, such as to stir the contents, or to check the progress of the cooking, and thus needs to be able to remove the lid. Sometimes the user may desire to not have to hold the lid while attending to the contents of the cooking vessel. In traditional cooking vessel assemblies, a user would place the lid on a surface, such as a countertop. In many such instances, condensation has built up on the inner surface of the lid. Thus, there is a need to assure that such condensation flows back into the vessel. However, this may damage the countertop if the lid is sufficiently hot, or make the counter top dirty if contents from the cooking vessel are on the lid. Further, often times water is used in a heating process with a stovetop cooking vessel, and this water must be drained from the food. Many times a user positions the lid on the cooking vessel such that water may leave the cooking vessel, but the contents of the cooking vessel are retained. However, this can result in food spilling out during the draining process if the lid is not maintained in a proper relationship with the cooking vessel.

Thus, a need exists for a lid for a cooking vessel assembly with a removable lid that is capable of being supported by the cooking vessel such that a user may access the contents of the vessel without needing to set the lid on another surface. Further, a need exists for a cooking vessel assembly with a lid that may be held to the cooking vessel in a manner to allow water to pass between the lid and the cooking vessel, while maintaining the food within the cooking vessel.

The present invention is provided to solve the problems discussed above and other problems, and to provide advantages and aspects not previously provided. A full discussion of the features and advantages of the present invention is deferred to the following detailed description, which proceeds with reference to the accompanying drawings.

### SUMMARY OF THE INVENTION

According to one embodiment, a cooking vessel assembly comprises a cooking vessel and a removable lid. The cooking vessel has a base and a continuous sidewall. The sidewall connects to the base and projects upwardly from the base and terminates at a peripheral edge. The removable lid has a covering portion and a handle. The handle has a gripping portion, a connecting section, and a supporting section. The connecting section connects the handle to the lid covering portion. The gripping section extends from the connecting section. The supporting section extends from the connecting section in a direction generally opposite of the gripping section. The supporting section has a cooking vessel retaining portion. A gap is formed between the connecting section and the supporting section. The cooking vessel retaining portion receives the peripheral edge of the cooking vessel to secure the lid to the cooking vessel in an open position to allow access to the base of the cooking vessel.

According to another embodiment, a lid for a cooking vessel comprises a covering portion, a handle, a first narrowing portion, and a second narrowing portion. The covering portion has a periphery. The handle has a gripping portion, a connecting section, and a supporting section. The connecting section connects the handle to the lid covering portion. The gripping section extends from the connecting section. The supporting section extends from the connecting section in a direction generally opposite of the gripping section. The supporting section has a cooking vessel retaining portion. A gap forms between the connecting section and the supporting section. The first narrowing portion is positioned along the periphery of the covering portion. The second narrowing portion is positioned along the periphery of the covering portion.

According to a further embodiment, a lid for a cooking vessel comprises a covering portion and a handle. The covering portion has a periphery. The handle has a gripping portion, a connecting section, and a supporting section. The connecting section connects the handle to the lid covering portion. The gripping section extends from the connecting section. The supporting section extends from the connecting section in a direction generally opposite of the gripping section. A gap is disposed between the connecting section and the supporting section. The supporting section further comprises a channel to additionally position and support the lid relative to a cooking vessel when the lid is in an open position.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a pictorial view of a cooking vessel assembly according to one embodiment with a lid in a closed position;

FIG. 2a depicts an isometric pictorial view of the cooking vessel assembly of FIG. 1;

FIG. 2b is a top view of the cooking vessel assembly of FIG. 1;

FIG. 2c is a front view of the cooking vessel assembly of FIG. 1;

FIG. 3 is a pictorial view of the cooking vessel assembly of FIG. 1 with the lid in an open resting position;

FIG. 4a is an isometric pictorial view of a cooking vessel assembly according to another embodiment;

FIG. 4b is a top view of the cooking vessel assembly of FIG. 4a;

FIG. 4c is a front view of the cooking vessel assembly of FIG. 4a;

FIG. 5 is a pictorial view of a lid for a cooking vessel according to one embodiment;

FIG. 6a is a cross sectional view of the lid of FIG. 5 taken along line 6a-6a;

FIG. 6b is a cross sectional view of the lid of FIG. 5 taken along line 6b-6b;

FIG. 7 is a pictorial view of a lid for a cooking vessel according to another embodiment;

FIG. 8a is a cross sectional view of the lid of FIG. 7 taken along line 8a-8a;

FIG. 8b is a cross sectional view of the lid of FIG. 7 taken along line 8b-8b;

FIG. 9 is pictorial view of a cooking vessel assembly with a lid in an open resting position according to a further embodiment;

FIG. 10 is a perspective view of a lid according to a further embodiment;

FIG. 11 is a rear view of the lid shown in FIG. 10;

FIG. 12 is a front view of the lid shown in FIG. 10;

FIG. 13 is a top view of the lid shown in FIG. 10;

FIG. 14 is a bottom view of the lid shown in FIG. 10;

FIG. 15 is a left side elevation view of the lid shown in FIG. 10; and

FIG. 16 is a right side elevation view of the lid shown in FIG. 10.

The components in the drawings are not necessarily to scale, emphasis instead being placed upon clearly illustrating the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

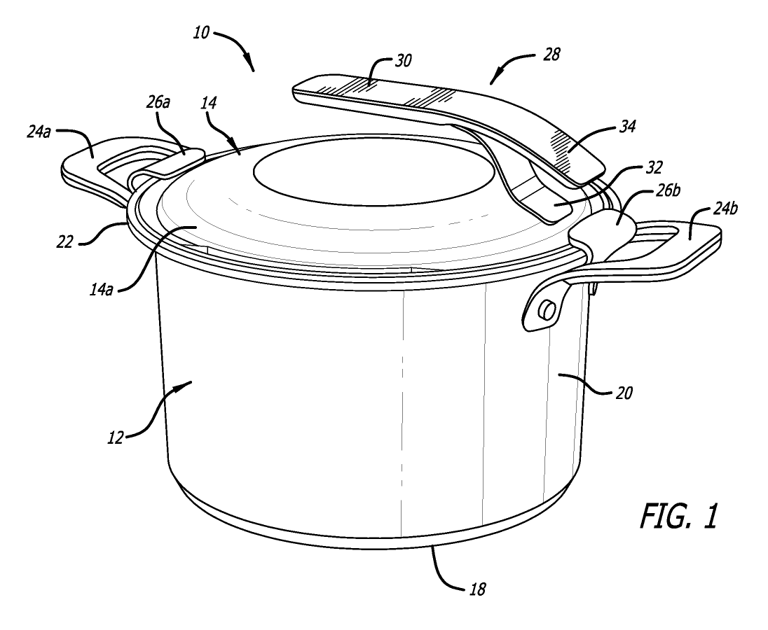

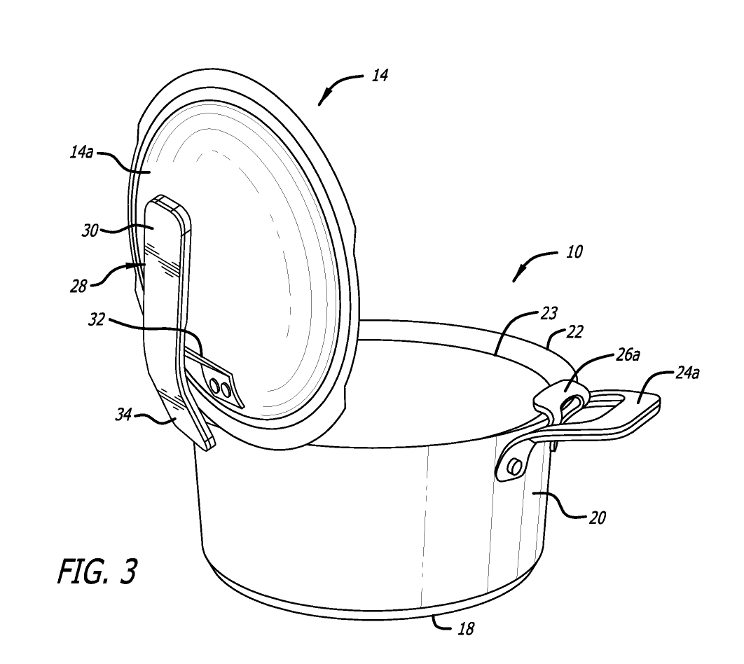

According to one embodiment shown in FIGS. 1-3, a cooking assembly 10 is provided. As will be discussed below, according to one aspect of the embodiment, the cooking assembly 10 comprises a cooking vessel 12, a lid portion 14. The cooking vessel 12 comprises a base portion 18 and a continuous sidewall 20 projecting upward from the base portion 18. The sidewall 20 begins at the base portion 18 and terminates at an upper peripheral edge 22. It is contemplated that the base portion 18 of the cooking vessel 12 may be provided in a variety of shapes, such as a circle, as shown in FIG. 1, a square, a triangle, an oval, a rectangular shape, or any other shape into which a cooking vessel may be configured. It is further contemplated that the edge 22 of the sidewall 20 may project outward of the base portion 18. The cooking vessel 12 further has a lid supporting ledge 23, as best shown in FIG. 3, that is located inward of the upper peripheral edge 22. The lid supporting ledge 23 supports the lid portion 14 when the lid portion 14 is in a closed position, such as that shown in FIG. 1.

The cooking vessel 12 additionally has a first handle 24a and a second handle 24b to allow a user to more easily lift the cooking vessel 12. Each of the handles 24a, 24b has a respective lid retaining portion 26a, 26b adapted to interact with the lid portion 14, as explained more fully below.

The lid portion 14 has covering portion 14a, a handle 28 with a gripping section 30, a lid connecting section 32, and a cooking vessel retaining portion 34. The gripping section 30 of the handle 28 is allows a user to easily grasp the handle 28 to manipulate and remove the lid portion 14 from the cooking vessel 12. The handle 28 additionally has a connecting section 32 that connects the handle 28 to the lid portion 14. The connecting section 32 may be connected to the lid portion 14 in a variety of manners, such as via rivets, bolts, other mechanical fasteners, or adhesives.

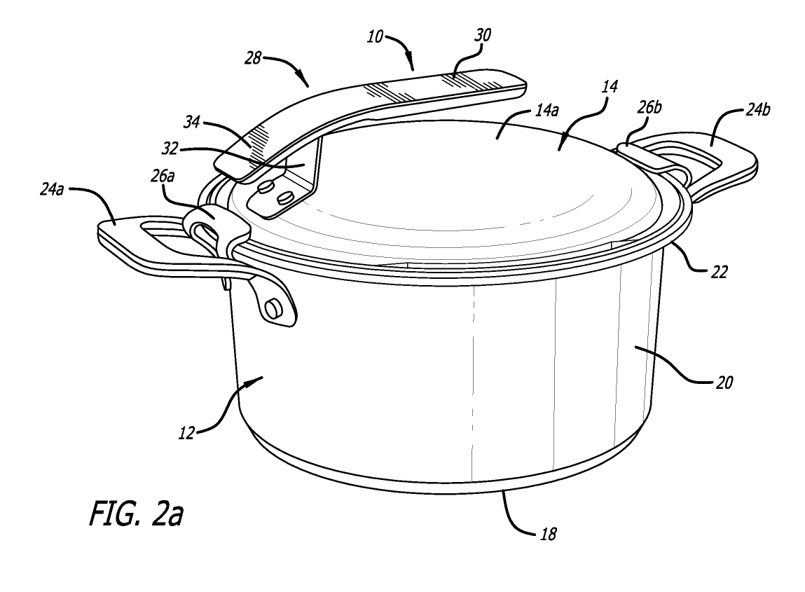

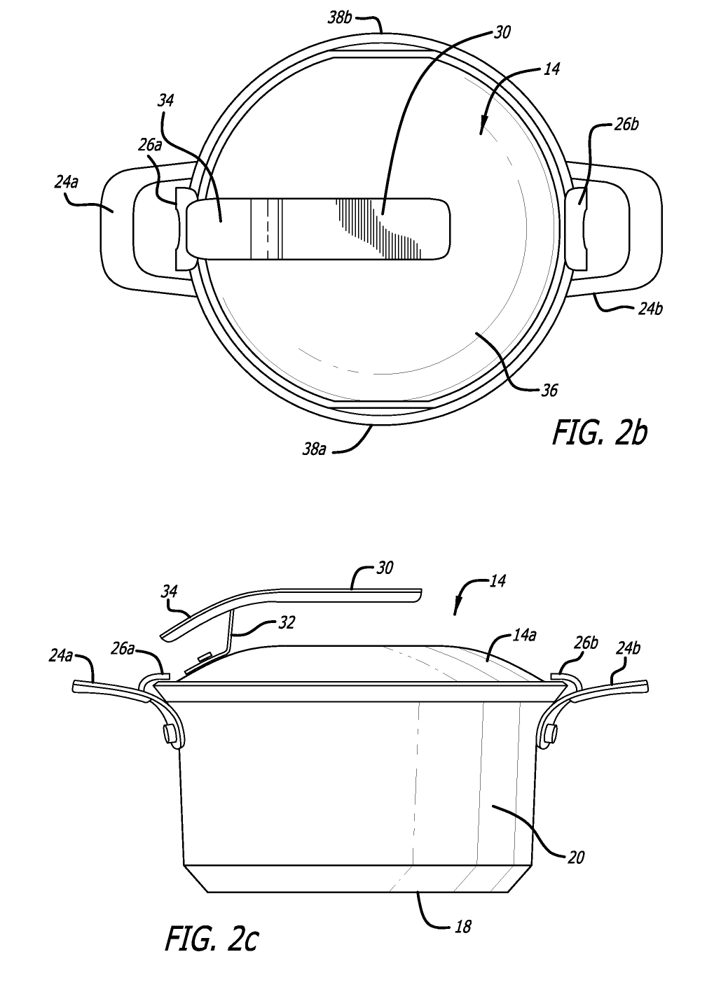

In addition to the gripping section 30 and the connecting section 32, the handle 28 further has a supporting section 34. As best viewed in FIGS. 2c and 3, the supporting section 34 and the connecting section 32 form a space that allows the lid portion 14 to be supported by the peripheral edge 22 of the cooking vessel 12. Supporting the lid portion 14 on the peripheral edge 22 of the cooking vessel 12 eliminates the need for the user to set the lid 14 on to a surface, such as a counter, or to hold the lid 14 within their hand while checking the contents of the cooking vessel 12. The lid 14 is positioned such that any fluids on the lid 14 will flow into the cooking vessel 12 as the lid 14 is positioned within the peripheral edge 22 of the cooking vessel 12.

As best shown in FIG. 2b, the lid 14 has a peripheral ring 36 that has a first narrowed portion 38a and a second narrowed portion 38b. As shown in FIGS. 2b and 2c, the peripheral ring 36 of the lid 14 is constrained by the lid retaining portions 26a, 26b of the cooking vessel 12. In order to remove the lid 14 from the cooking vessel 12, the lid is rotated until the first and second narrowed portion 38a, 38b align with the lid retaining portions 26a, 26b. Once this lid 14 and cooking vessel 12 orientation is obtained, the lid 14 may be removed, as the narrowed portions 38a, 38b are dimensioned to be positioned inside of the lid retaining portions 26a, 26b, facilitating removal of the lid 14.

As shown in FIG. 2c, a gap exists between the covering portion 14a of the lid 14 and the lid retaining portions 26a, 26b of the cooking vessel 12. This gap allows water, or other liquid contents of the cooking vessel assembly 10 to be drained, while the lid 14 is retained by the lid retaining portions 26a, 26b of the cooking vessel 12. Therefore a user does not have to maintain the relationship between the lid 14 and the cooking vessel 12 to drain the cooking vessel assembly 10.

As shown in FIGS. 1-3, the cooking vessel 12 is a sauce pan, such as a three quart sauce pan. The cooking vessel 12 may be formed from a variety of materials, several non-limiting examples include aluminum, stainless steel, anodized aluminum, and copper. Further, it is contemplated that the cooking vessel 12 may have a non-stick coating, such as Teflon. It is additionally contemplated that a cooking vessel may include a wide variety of pots or pans, such as a frying pan, a stock pan, or a sauté pan, and that the cooking vessel may be of various sizes and capacities.

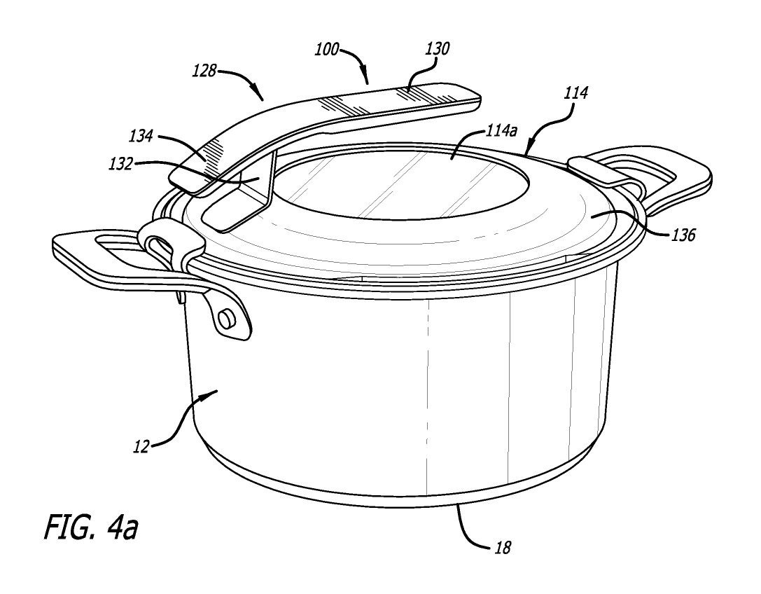

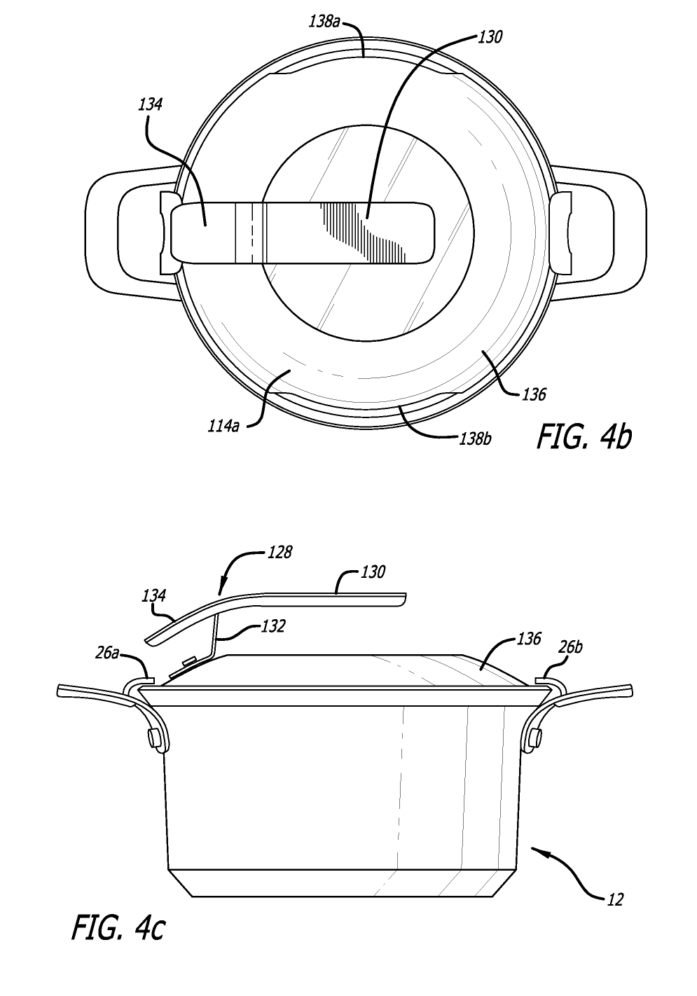

Turning now to FIGS. 4a-4c, a cooking vessel assembly 100 is shown. The cooking vessel assembly 100 comprises the cooking vessel 12 and a lid portion 114. The lid portion 114 has a covering portion 114a, a handle 128 with a gripping section 130, a lid connecting section 132, and a cooking vessel retaining portion 134. The gripping section 130 of the handle 128 is adapted to allow a user to easily grasp the handle 128 to remove the lid portion 114 from the cooking vessel 12. The handle 128 additionally has a connecting section 132 that connects the handle 128 to the lid portion 114. The connecting section 132 shown in FIGS. 4a-4c attaches to a peripheral portion 136 that extends in towards the center of the lid portion 114 from the periphery. The peripheral portion 136 may be formed of metal allowing the connecting section 132 to connect to the peripheral portion in a variety of manners, such as via rivets, bolts, other mechanical fasteners, adhesives, or welding. The peripheral portion 136 may provide additional protection from breaking of the lid portion 114, as the metal peripheral portion 136 is less likely to break from contact with the peripheral edge 22 of the cooking vessel 12, or from the lid retaining portions 26a, 26b.

In addition to the gripping section 130 and the connecting section 132, the handle 128 further has a supporting section 134. The supporting section 134 and the connecting section 132 form a space that allows the lid portion 114 to be supported by the peripheral edge 22 of the cooking vessel 12, such as shown in the first embodiment depicted in FIGS. 1-3.

As best shown in FIG. 4b the peripheral portion 136 of the lid 114 has a first narrowed portion 138a and a second narrowed portion 138b. As shown in FIGS. 4b and 4c, the peripheral portion 136 of the lid 114 is constrained by the lid retaining portions 26a, 26b of the cooking vessel 12. In order to remove the lid 114 from the cooking vessel 12, the lid is rotated until the first and second narrowed portion 138a, 138b align with the lid retaining portions 26a, 26b. Once this lid 114 and cooking vessel 12 orientation is obtained, the lid 114 may be removed, as the narrowed portions 138a, 138b are dimensioned to be positioned inside of the lid retaining portions 26a, 26b, facilitating removal of the lid 114.

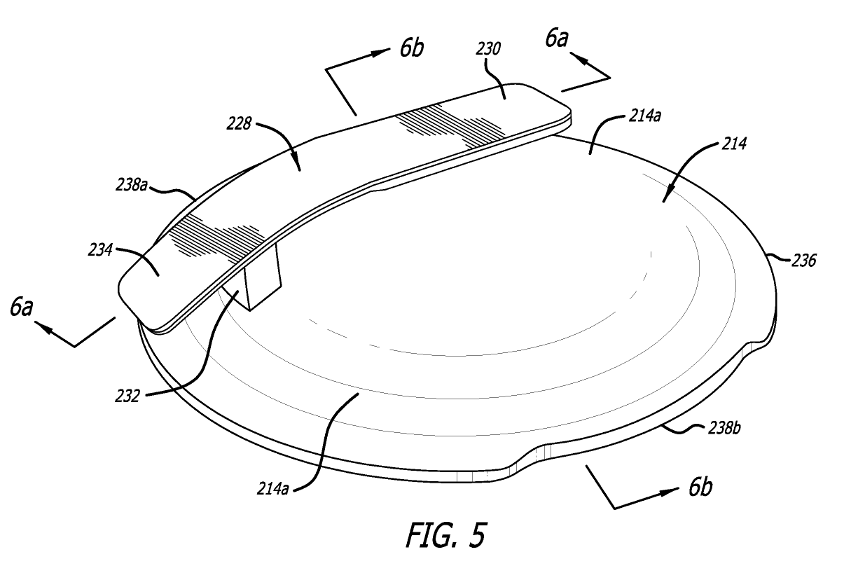

Turning now to FIG. 5, a lid portion 214 is depicted that is adapted to be used with a cooking vessel assembly. It is contemplated that the lid portion 214 may be manufactured from press glass. The lid portion 214 comprises a covering portion 214a, a handle 228, a periphery 236 having a first narrowed portion 238a and a second narrowed portion 238b. The narrowed portions 238a, 238b allow the lid portion 214 to be removed from the cooking vessel. The handle 228 has a gripping section 230, a lid connecting section 232, and a cooking vessel retaining portion 234. The gripping section 230 of the handle 228 is adapted to allow a user to easily grasp the handle 228 to remove the lid portion 214 from the cooking vessel. The handle 228 additionally has a connecting section 232 that connects the handle 228 to the lid portion 214.

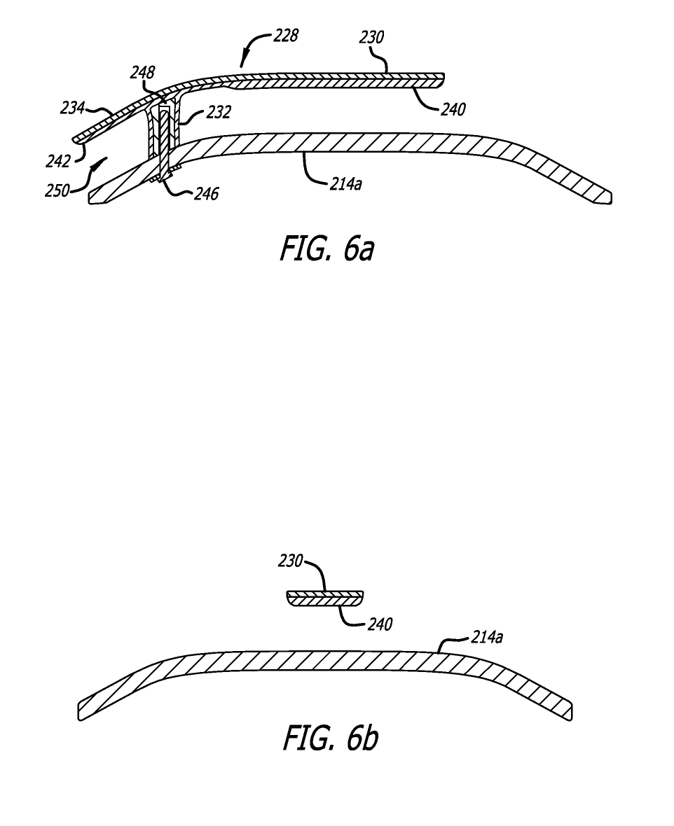

As shown in FIGS. 6a and 6b, the gripping section 230 has a silicone coating 240 applied to further enhance the user's ability to grasp the gripping section 230. The use of silicone coating 240 additionally may provide thermal insulation, reducing the likelihood of the user obtaining a burn from grasping the gripping section 230.

The connecting section 232 shown in FIG. 6a attaches to the lid 214 via a fastener 246. The connecting section 232 contains a resin 248 that receives the fastener 246 to secure the handle 228 to the lid 214.

In addition to the gripping section 230 and the connecting section 232, the handle 228 further has a supporting section 234. The supporting section 234 and the connecting section 232 form a space 250 that allows the lid portion 214 to be supported by a peripheral edge of a cooking vessel, such as shown in the first embodiment depicted in FIGS. 1-3. As shown in FIG. 6a, the supporting section 234 additionally has a silicone coating 242 to provide additional friction to secure the lid 214 to the container.

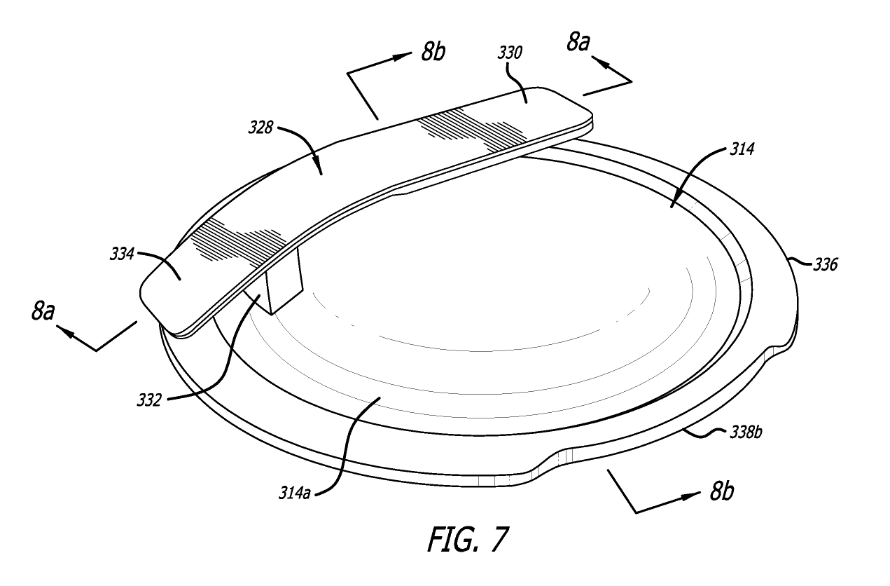

Turning now to FIG. 7, a lid portion 314 is depicted that is adapted to be used with a cooking vessel assembly. It is contemplated that the lid portion 314 may be manufactured from sag glass. The lid portion 314 comprises a covering portion 314a, a handle 328, a silicone peripheral gasket 336 having a first narrowed portion 338a and a second narrowed portion 338b. The narrowed portions 338a, 338b allow the lid portion 314 to be removed from the cooking vessel. The silicone peripheral gasket 336 reduces the likelihood of breaking the sag glass of the lid 314, and the silicone gasket 336 provides a better seal between the lid 314 and the cooking vessel. The handle 328 has a gripping section 330, a lid connecting section 332, and a cooking vessel retaining portion 334. The gripping section 330 of the handle 328 is adapted to allow a user to easily grasp the handle 328 to remove the lid portion 314 from the cooking vessel. The handle 328 additionally has a connecting section 332 that connects the handle 328 to the lid portion 314.

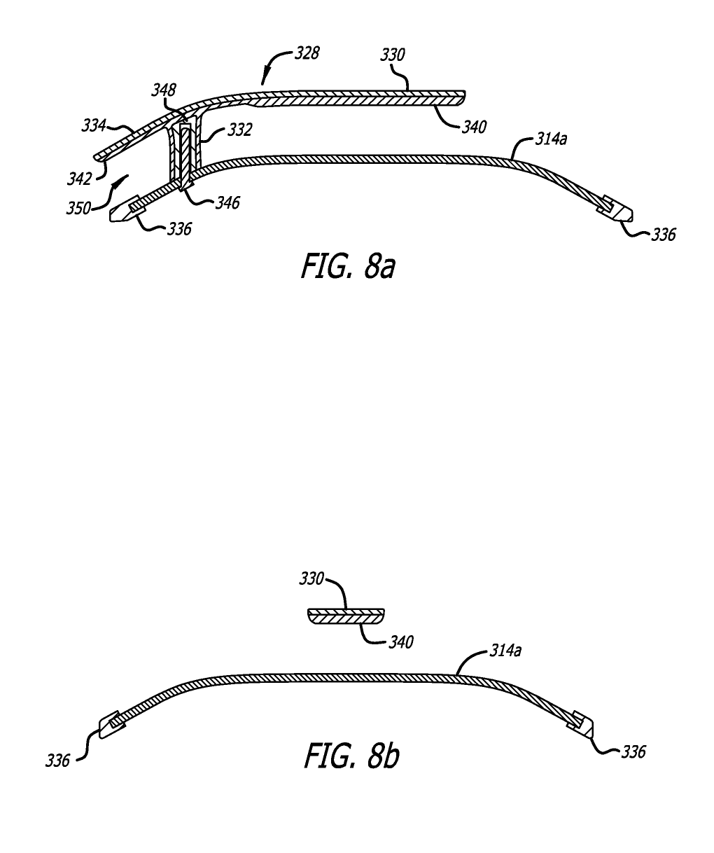

As shown in FIGS. 8a and 8b, the gripping section 330 has a silicone coating 340 applied to further enhance the user's ability to grasp the gripping section 330. The use of silicone coating 340 additionally may provide thermal insulation, reducing the likelihood of the user obtaining a burn from grasping the gripping section 330.

The connecting section 332 shown in FIG. 8a attaches to the lid 314 via a fastener 346. The connecting section 332 contains a resin 348 that receives the fastener 346 to secure the handle 328 to the lid 314.

In addition to the gripping section 330 and the connecting section 332, the handle 328 further has a supporting section 334. The supporting section 334 and the connecting section 332 form a space 350 that allows the lid portion 314 to be supported by a peripheral edge of a cooking vessel, such as shown in the first embodiment depicted in FIGS. 1-3. As shown in FIG. 8a, the supporting section 334 additionally has a silicone coating 342 to provide additional friction to secure the lid 314 to the container.

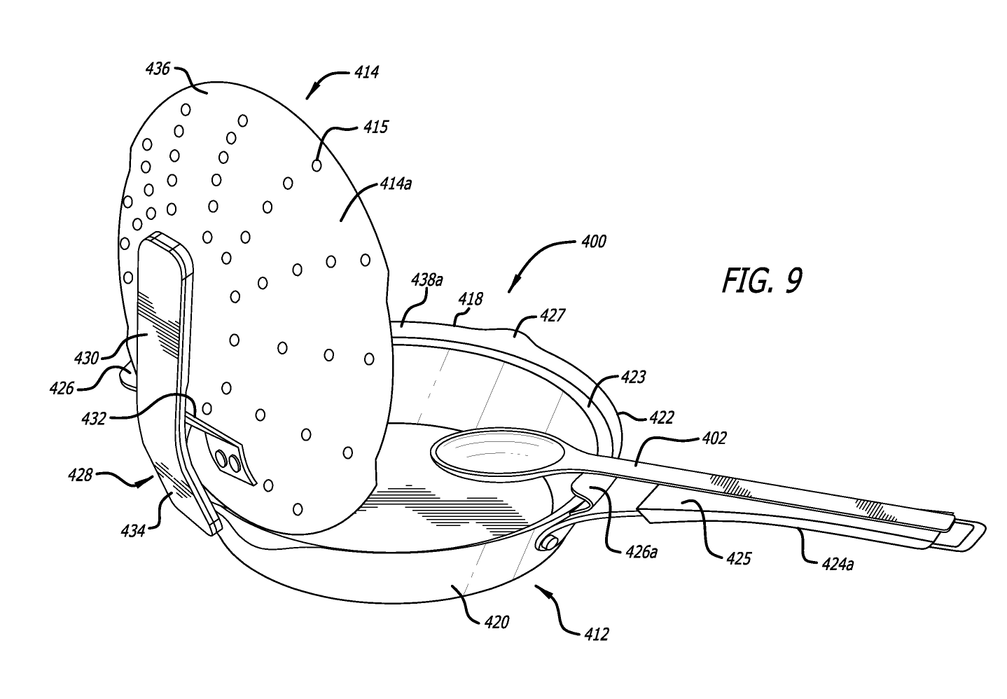

Referring next to FIG. 9, a cooking vessel assembly 400 is depicted having a cooking vessel 412 and a lid portion 414. The cooking vessel 412 comprises a base portion 418 and a continuous sidewall 420 projecting upward from the base portion 418. The sidewall 420 begins at the base portion 418 and terminates at an upper peripheral edge 422. It is contemplated that the base portion 418 of the cooking vessel 412 may be provided in a variety of shapes, such as a circle, as shown in FIG. 9, a square, a triangle, an oval, a rectangular shape, or any other shape into which a cooking vessel may be configured. It is further contemplated that the edge 422 of the sidewall 420 may project outward of the base portion 418. The cooking vessel 412 further has a lid supporting ledge 423, that is located inward of the upper peripheral edge 422. The lid supporting ledge 423 is adapted to support the lid portion 414 when the lid portion 414 is closed. Additionally, a pouring spout 427 may be provided on the upper peripheral ledge to allow liquids to be more easily poured from the cooking vessel 412.

The cooking vessel 412 additionally has a first handle 424a and may optionally have a second handle (not shown) to allow a user to more easily lift the cooking vessel 412. The cooking vessel 412 has a first lid retaining portion 426a and a second lid retaining portion 426b adapted to interact with the lid portion 414, as explained more fully below. As shown in FIG. 9, the cooking vessel 420 is a frying pan having an elongated handle 424a. The handle 424a has a grip portion 425 to assist the user in grasping the handle 424a. The grip portion 425 additionally acts as a support for a cooking utensil 402. The grip portion and the first lid retaining portion 426a may be used to support the cooking utensil 402 such that the working end of the cooking utensil 402 is located inside the upper peripheral edge 422, preventing any food on the cooking utensil 402 soiling a surface such as a countertop or stovetop.

The lid portion 414 has a covering portion 414a, a handle 428 with a gripping section 430, a lid connecting section 432, and a cooking vessel retaining portion 434. The gripping section 430 of the handle 428 is adapted to allow a user to easily grasp the handle 428 to remove the lid portion 414 from the cooking vessel 412. The handle 428 additionally has a connecting section 432 that connects the handle 428 to the lid portion 414. The connecting section 432 may be connected to the lid portion 414 in a variety of manners, including, but not limited to, rivets, bolts, other mechanical fasteners, adhesives, welding, or brazing.

In addition to the gripping section 430 and the connecting section 432, the handle 428 further has a supporting section 434. The supporting section 434 and the connecting section 432 form a space that allows the lid portion 414 to be supported by the peripheral edge 422 of the cooking vessel 412. Supporting the lid portion 414 on the peripheral edge 422 of the cooking vessel 412 eliminates the need for the user to set the lid 414 onto a surface, such as a counter, or to hold the lid 414 within their hand while checking the contents of the cooking vessel 412. The lid 414 is positioned such that any fluids on the lid 414 will flow into the cooking vessel 412 as the lid 414 is positioned within the peripheral edge 422 of the cooking vessel 412.

The lid 414 has a peripheral edge 436 that has a first narrowed portion 438a and a second narrowed portion (not shown). The peripheral edge 436 of the lid 414 is adapted to be constrained by the lid retaining portions 426a, 426b of the cooking vessel 412 when the lid 414 is in a closed position. In order to remove the lid 414 from the cooking vessel 412, the lid is rotated until the first narrowed portion 438a and the second narrowed portion align with the lid retaining portions 426a, 426b. Once this lid 414 and cooking vessel 412 orientation is obtained, the lid 414 may be removed, as the narrowed portions are dimensioned to be positioned inside of the lid retaining portions 426a, 246b, facilitating removal of the lid 414.

The lid 414 depicted in FIG. 9 has a plurality of vent openings 415 formed therein. The openings 415 allow the lid 414 to function as a splatter guard, as the lid 414 is adapted to be used with a cooking vessel 412 that is a frying pan. As such, the openings 415 allow steam to escape the cooking vessel assembly 400, but reduce the amount of liquids that may exit the cooking vessel 412.

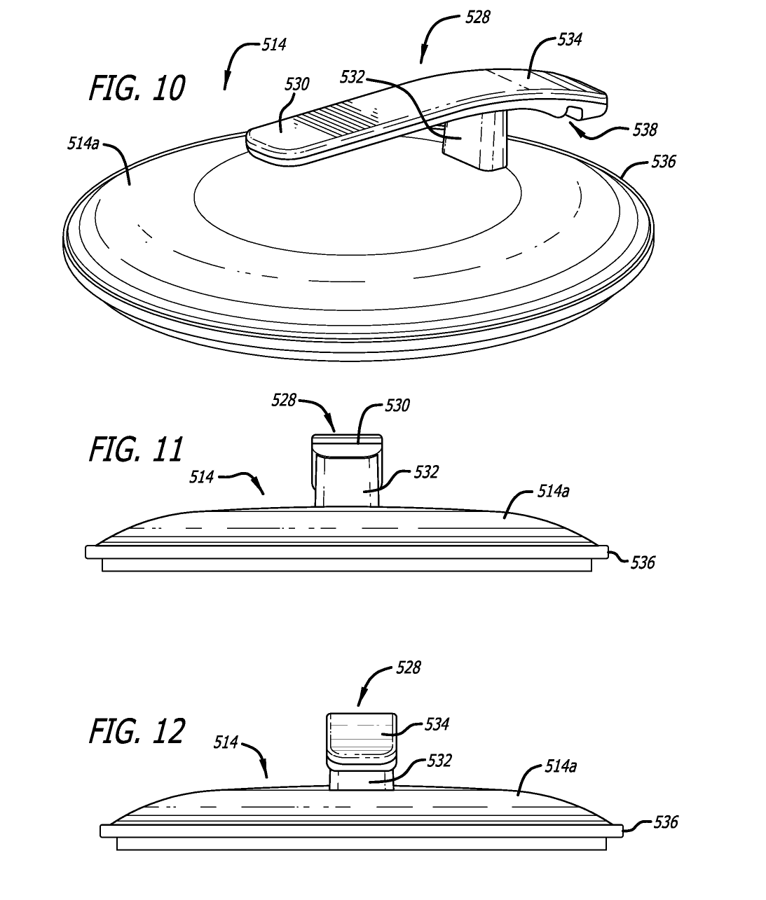

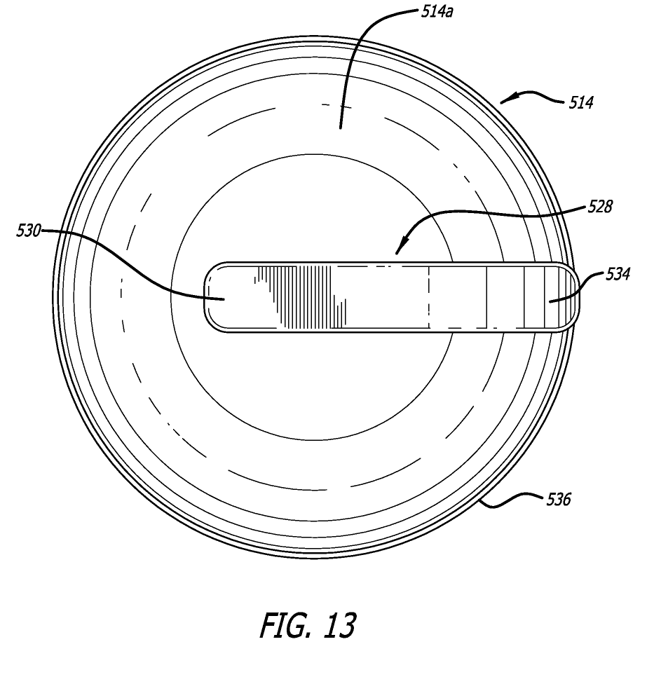

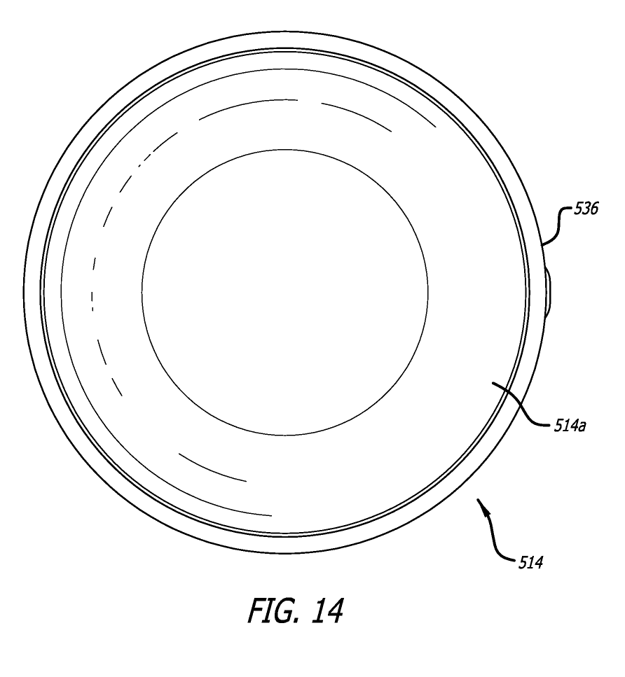

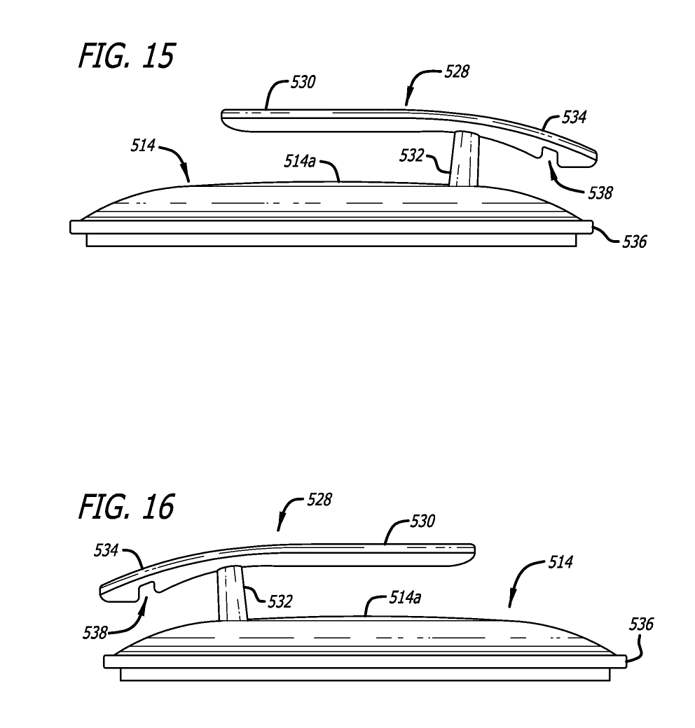

FIGS. 10-16 depict a lid portion 514 adapted for use with a cooking vessel assembly according to a further embodiment. It is contemplated that the lid portion 514 may be manufactured from glass, metal, or a combination of materials. The lid portion 514 comprises a covering portion 514a, a handle 528, and a periphery 536. The handle 528 has a gripping section 530, a lid connecting section 532, and supporting section 534 having a cooking vessel retaining portion 538. The gripping section 530 of the handle 528 is adapted to allow a user to easily grasp the handle 528 to remove the lid portion 514 from the cooking vessel.

The lid connecting section 532 connects the handle 528 to the lid portion 514. The connecting section 532 may be attached to the lid 514 in a variety of manners, such as via a mechanical fastener, an adhesive, or other known fastening methods.

In addition to the gripping section 530 and the connecting section 532, the handle 528 further has a supporting section 534. The supporting section 534 and the connecting section 532 form a space 550 that allows the lid portion 514 to be supported by a peripheral edge of a cooking vessel, such as shown in the first embodiment depicted in FIGS. 1-3. As shown in FIGS. 10-16, the supporting section 534 additionally contains the cooking vessel retaining portion 538. The cooking vessel retaining portion 538 is shown in the form of a channel in FIGS. 10-16, however, it is contemplated, that other structures may be used, such as a protrusion, a recess, or other feature. The cooking vessel retaining portion 538 is adapted to be placed over the peripheral edge of a cooking vessel to more securely fix the lid 514 to the cooking vessel when the lid 514 is in an open position.

The lid 514 may be manufactured from a variety of materials, including, but not limited to, glass, aluminum, stainless steel, and combinations thereof

It is contemplated that narrowed portions may be provided along the periphery 536 of the lid 514 in order to secure the lid 514 to a container while in use.

While the specific embodiments have been illustrated and described, numerous modifications come to mind without significantly departing from the spirit of the invention, and the scope of protection is only limited by the scope of the accompanying Claims.

What is claimed is:

1. A cooking vessel assembly comprising:
a cooking vessel having a base and a continuous sidewall, the sidewall projecting upwardly from the base and terminating at a peripheral edge; and
a removable lid comprising a covering portion, a connection section, and a handle connected to the lid covering portion by a connection section, the handle having a gripping portion extending in a first direction and a supporting section extending in a second direction generally opposed to the first direction, a gap is formed between the connecting section and the supporting section, and wherein the cooking vessel retaining portion is configured to receive the peripheral edge of the cooking vessel and releasably secures the lid to the cooking vessel in an open position, and wherein the supporting section includes a cooking vessel retaining portion.

2. The cooking vessel assembly of claim 1, wherein the peripheral edge of the cooking vessel contacts the connecting section of the handle with the lid in the open position.

3. The cooking vessel assembly of claim 1, wherein the peripheral edge of the cooking vessel contacts the supporting section of the handle with the lid in the open position.

4. The cooking vessel assembly of claim 3, wherein the cooking vessel retaining portion comprises a channel to receive a portion of the peripheral edge of the cooking vessel with the lid in an open position.

5. The cooking vessel assembly of claim 1, wherein the cooking vessel further comprises a first lid retaining portion and a second lid retaining portion, at least a portion of the first and second lid retaining portions being positioned above the peripheral edge and located proximal to the center of the cooking vessel relative to the peripheral edge of the cooking vessel; and
the lid further comprising a first narrowed portion located about the periphery of the lid, and a second narrowed portion located about the periphery of the rim, the first and second lid retaining portion extending within the periphery of the rim of the lid to secure the lid to the cooking vessel; and
wherein the lid is configured to be removed from the cooking vessel when the first and second narrowed portions of the periphery of the lid are aligned with the first and second lid retaining portions.

6. The cooking vessel assembly of claim 5 wherein the first lid retaining portion extends from a first handle connected to the cooking vessel, and the second lid retaining portion extends from a second handle connected to the cooking vessel.

7. The cooking vessel assembly of claim 1, wherein the removable lid further comprises a silicone coating at a periphery of the covering portion.

8. The cooking vessel assembly of claim 1, wherein the removable lid further comprises a first silicone coating on the gripping section and a second silicone coating on the supporting section.

9. The cooking vessel assembly of claim 1, wherein the lid covering portion is formed from one of either borosilicate glass and soda-lime glass.

10. The cooking vessel assembly of claim 1, wherein the lid covering portion is formed from metal.

11. A lid for a cooking vessel comprising:
a covering portion having a periphery;
a handle connected to the lid covering portion by a connection section, the handle having a gripping portion extending in a first direction and a supporting section extending in a second direction, the second direction being generally opposed to the first direction, the gripping section having a cooking vessel retaining portion, wherein a gap is formed between the connecting section and the supporting section and the wherein the cooking vessel retaining portion is configured to receive the peripheral edge of the cooking vessel and releasably secures the lid to the cooking vessel in an open position;
a first narrowing portion along the periphery of the covering portion; and
a second narrowing portion along the periphery of the covering portion.

12. The lid for a cooking vessel of claim 11, wherein the connecting section of the handle is configured to contact a peripheral edge of a cooking vessel to releasably secure the lid to the cooking vessel in an open position.

13. The lid for a cooking vessel of claim 11, wherein the supporting section of the handle is configured to contact a peripheral edge of a cooking vessel to releasably secure the lid to the cooking vessel in an open position.

14. The lid for a cooking vessel of claim 13, wherein the cooking vessel retaining portion comprises a channel to additionally position and support the lid relative to a cooking vessel when the lid is in an open position.

15. The lid for a cooking vessel of claim 11, wherein the lid covering portion is formed from one of either borosilicate glass and soda-lime glass.

16. The lid for a cooking vessel of claim 11, wherein the lid covering portion is formed from metal.

17. The lid for a cooking vessel of claim 16, wherein the covering portion comprises a plurality of vent openings.

18. A lid for a cooking vessel comprising:
a covering portion having a periphery; and
a handle connected to the lid covering portion by a connection section, the handle having a gripping portion extending in a first direction and a supporting section extending in a second direction generally opposed to the first direction, wherein a gap is formed between the connecting section and the supporting section, and wherein the supporting section includes a channel configured to position and support the lid relative to a cooking vessel when the lid is in an open position.

19. The lid of claim 18, further comprising a silicone coating at a periphery of the covering portion.

20. The lid of claim 18, further comprising a first silicone coating on the gripping section and a second silicone coating on the supporting section.
